(19) United States
(12) Patent Application Publication
(10) Pub. No.: US 2026/0273775 A1
(43) Pub. Date: Sep. 17, 2026

(54) GRIPPER HEAD

(71) Applicant: KRONES AG, Neutraubling (DE)

(72) Inventors: Michael NEUBAUER, Grassau (DE); Martin WAGNER, Regensburg (DE)

(21) Appl. No.: 19/564,569

(22) Filed: Mar. 12, 2026

(30) Foreign Application Priority Data
Mar. 12, 2025 (DE) 10 2025 109 363.6

(51) Int. Cl. B25J 15/00; B25J 15/06

(52) U.S. Cl. CPC B25J 15/0066; B25J 15/0047; B25J 15/0616

(57) ABSTRACT

Disclosed is a gripper head with at least one gripping apparatus for label rolls and with a receiving apparatus for planar intermediate layers. The gripping apparatus for gripping the label rolls is fixedly arranged in the gripper head, while the receiving apparatus for the planar intermediate layers is movable in a linear direction relative to the position of the gripping apparatus location-variably and between two end positions.

### CROSS-REFERENCE TO RELATED APPLICATIONS

This application claims the benefit under 35 U.S.C. §119(a) of German Patent Application No. DE 10 2025 109 363.6, filed Mar. 12, 2025, entitled GRIPPER HEAD, and whose entire disclosure is incorporated by reference herein.

### Technical Field

The present invention relates to a gripper head according to the features of the preamble of the independent claim.

In particular, the invention relates to a gripper head, which can also be described as a combination gripper, for example both for and in conjunction with an apparatus suitable for operator-free label roll changing for handling label rolls and intermediate layers.

### Technical Background

Labels are usually available as continuous webs wound onto rolls, also known as label rolls. The labels can include not only ordinary labels that are affixed to a product or packaging, but also, for example, so-called wraparound labels.

To achieve economically efficient processes, a label roll change that can be carried out fully automatically without intervention from operating personnel is desirable.

After an old, empty label roll is used up, it is replaced by a new, full label roll using a robot-assisted apparatus.

The label rolls are stacked on pallets, ready for use, as is common in industrial processes. In this process, several label rolls are located in the same plane within a pallet stack. In successive planes, the label rolls are usually stacked vertically in alignment on top of each other in towers. Several towers stand side by side on a full pallet. To ensure trouble-free, automated handling of full pallets, intermediate layers are inserted in some planes. These connect the towers on a pallet at, for example, regular intervals corresponding to a predetermined number of stacked label rolls and stabilize them during handling, especially when moving the full pallets.

It is also known that there is even an intermediate layer between each stack of label rolls.

These intermediate layers are often made of corrugated board, cardboard or plastic.

To enable operator-free label roll changes, after the last label roll has been removed from an intermediate layer, this layer must be removed when the corresponding plane is reached. Ideally, this should be done in a smooth, uninterrupted alternation with the removal of the label rolls from the towers.

A robot specifically provided for the purpose of removing intermediate layers, which, for the purpose of fully automated, operator-free label roll changing, must then be provided in addition to a robot with a gripper head for changing the label roll, poses the risk of a collision between the two robots and is also highly inefficient with regard to the utilization of two robots.

DE 199 28 145 C2 discloses an apparatus for handling different bottles and different container shapes of bottles. It comprises a gripping device with a head consisting of two different grippers adapted to a specific container shape, which are held together on the gripping device and used alternately. For example, the head can be rotated to allow for the alternating use of the two grippers.

WO 2023/170269 A1 discloses an apparatus for labeling and handling rolls of web material. The apparatus comprises a labeling robot for applying labels to the rolls and a handling robot for handling the rolls. At the head of the handling robot, a first element for gripping and handling the rollers is arranged, which engages in the central opening of the rollers. A second element for gripping and handling the rollers can be arranged at the head of the handling robot, which attacks the rollers on their outer circumference. An intermediate layer gripper can also be arranged at the head of the handling robot. The intermediate layer gripper may comprise suction cups suitable for suctioning the intermediate layers. The intermediate layer gripper and the first element, as well as the second element if provided, are aligned along a first axis in opposite directions and arranged on opposite sides of the head of the handling robot. By pivoting the head 180° around a second axis that is normally positioned on the first axis, either: in a first rotation position the first element and the second element, if present, engage with a roller, or in a second rotation position the intermediate layer gripper handles an intermediate layer that is or will be inserted between the rollers.

One objective of the invention is to create the conditions for a cost-effective, fully automated and operator-free label roll change.

### SUMMARY OF THE INVENTION

The above object is achieved by the features of the independent apparatus claim. Advantageous embodiments are described in the claims, the drawings and the following description, including those relating to the drawings.

Additional advantages over the prior art, beyond a complete solution of the problem underlying the invention, result from gripping the intermediate layers with the same gripper head that is also used to grip the label rolls and lift them from the pallet. In particular, compared to the state of the art, this avoids both an unnecessary tool change on a robot carrying the gripper head, which can be described as a combination gripper, and eliminates the need for operator intervention to manually remove the intermediate layers from the pallet providing the label rolls.

Only then are the prerequisites created for a fully automated label roll change.

Other particularly noteworthy advantages include:

The realization of a process-reliable removal of the intermediate layers from packaging pallets by a robot.

A modular configuration option whereby the intermediate layer gripper can be modularly attached to a label roll gripper forming the main gripper.

The suction cups, preferably referred to as receiving means for short, for receiving the intermediate layers of the intermediate layer gripper and preferably configured as negative pressure or vacuum suction cups, are movable in such a way that they do not collide with the label rolls to be received in the retracted position. This enables, firstly, a reliable process for handling the label rolls. On the other hand, the vacuum suction cups are protected from mechanical damage by retraction. In the extended position, the suction cups are positioned so that the intermediate layers can be picked up without coming into contact with the components of the main gripper.

The intermediate layers can be laid flat after being lifted off. Alternatively, they can be fed into a press or shredder, or impaled on a suitable apparatus in a substantially perpendicular orientation.

### BRIEF DESCRIPTION OF THE FIGURES

Exemplary embodiments of the invention and their advantages are explained in more detail below with reference to the accompanying figures. The proportions of the individual elements relative to one another in the figures do not always correspond to the actual proportions since some forms are simplified, while other forms are shown enlarged in relation to other elements for better illustration. Identical reference signs are used for identical elements of the invention or those having the same effect. Furthermore, for the sake of clarity, only reference signs are shown in the individual figures, which are required for the description of the respective figure. The embodiments shown are merely examples of how the invention can be configured and do not represent an exhaustive limitation, with the figures below showing different details in schematic representations.

FIG. 1 shows an embodiment of a gripper head with a gripping apparatus for label rolls, referred to for short as a label roll gripper, and with a receiving apparatus for planar intermediate layers, referred to for short as an intermediate layer gripper, in a perspective view.

FIG. 2 shows an embodiment of a receiving apparatus for planar intermediate layers, which can also be called an intermediate layer gripper, and which can be retrofitted to a gripper head with a gripping apparatus for label rolls or to a label roll gripper, in a perspective view.

FIG. 3 shows the gripper head from FIG. 1 in a first working position, which corresponds to a first end position A, in which the intermediate layer gripper is extended relative to the gripping apparatus for label rolls along a geometric axis of the gripper head in order to bring the intermediate layer gripper with its receiving means preferably configured as suction cups into a favorable position for placing or resting on an intermediate layer, without being restricted by the engagement area of the gripping apparatus for label rolls, in a side view.

FIG. 4 shows the gripper head from FIG. 1 in a second working position, which corresponds to a second end position B, in which the intermediate layer gripper is retracted relative to the gripping apparatus for label rolls along a geometric axis of the gripper head in order to release an engagement area for label rolls for the gripping apparatus for label rolls, in a side view.

FIG. 5 shows an embodiment of a magazine for storing intermediate layers lifted from a pallet of label rolls in a perspective view in FIG. 5a) and with intermediate layers mounted on it in a side view in FIG. 5b), which magazine can be part of a gripper head with at least one gripping apparatus for label rolls and with a receiving apparatus for planar intermediate layers or an apparatus comprising such a gripper head for handling label rolls and intermediate layers.

Identical reference signs are used for identical elements of the invention or those having the same effect. Furthermore, for the sake of clarity, only reference signs are shown in the individual figures, which are required for the description of the respective figure. The illustrated embodiments are merely examples of how the gripper head according to the invention can be configured, and are non-limiting.

### DETAILED DESCRIPTION OF EMBODIMENTS

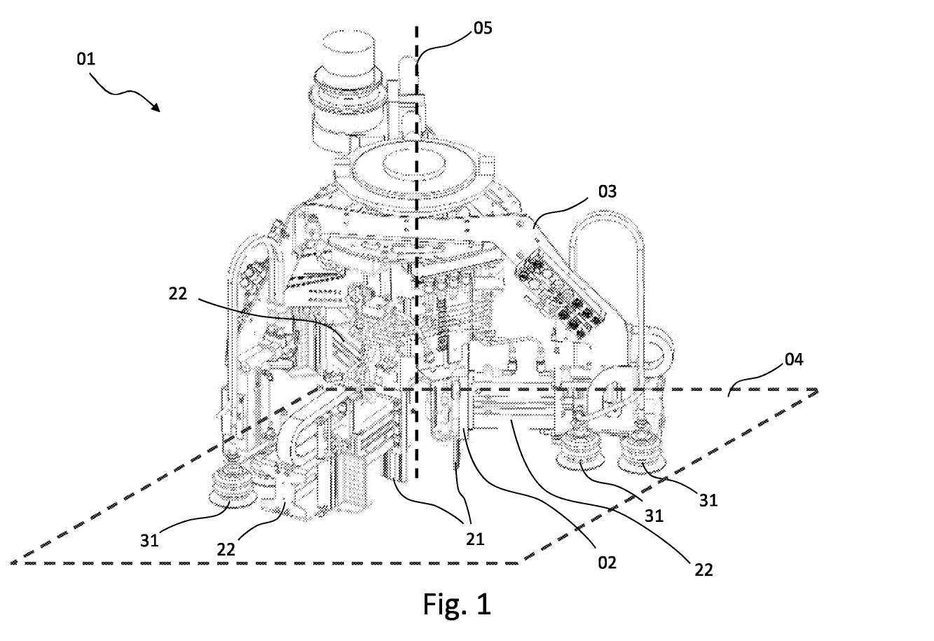

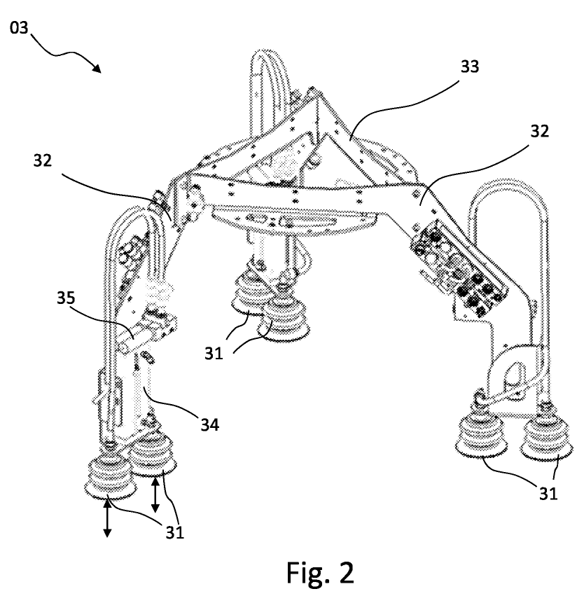

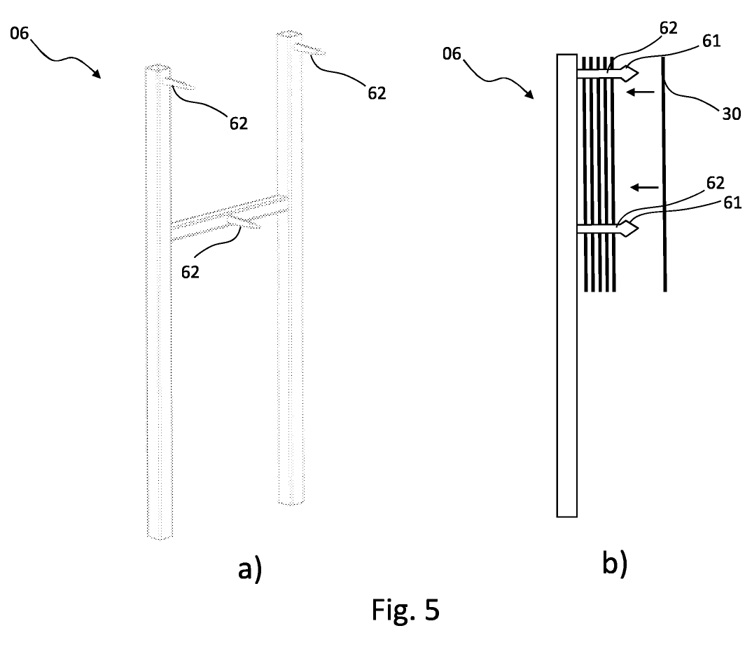

A gripper head 01 shown in whole or in part in FIGS. 1, 2, 3, 4 and 5 is equipped with at least one gripping apparatus 02 for label rolls 20 and with a receiving apparatus 03 for planar intermediate layers 30.

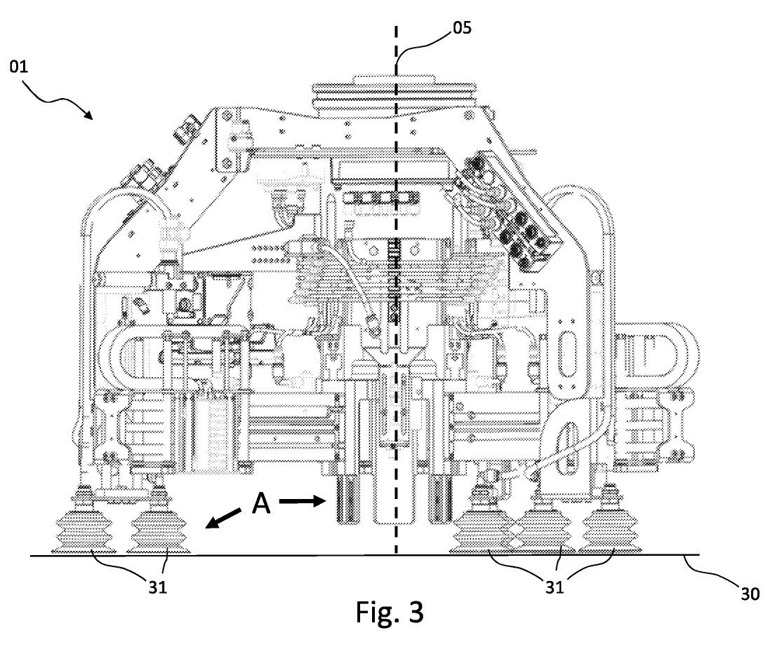

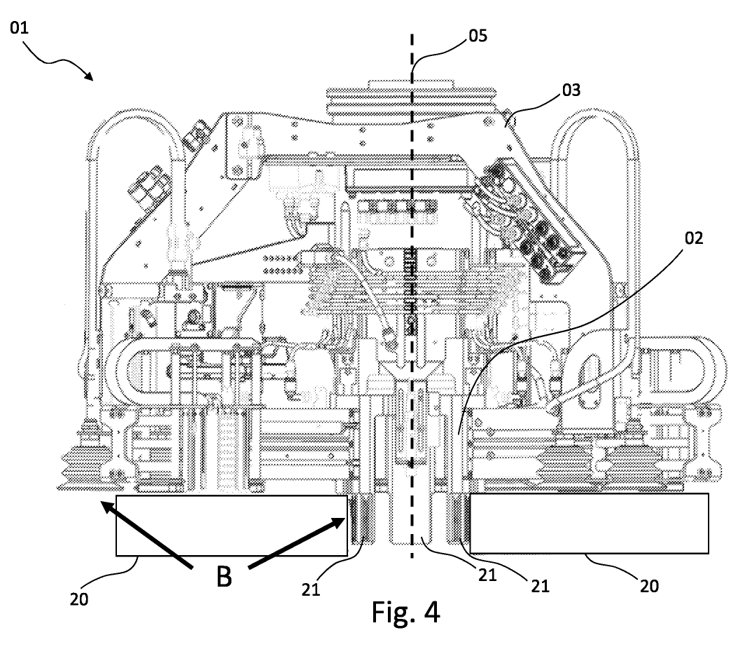

The gripping apparatus 02 for grasping the label rolls 20 can advantageously be arranged in a fixed position in the gripper head. The receiving apparatus 03 for the planar intermediate layers 30 is movable location-variably and in a linear direction between two end positions A, B shown by way of example in FIGS. 3 and 4 relative to the position of the gripping apparatus 02.

In other words, in the gripper head 01, the receiving apparatus 03 for planar intermediate layers 30, also referred to as the intermediate layer gripper, is linearly movable relative to the gripping apparatus 02, which can also be called the label roll gripper, for gripping the label rolls 20.

However, in principle, linear movement of the label roll gripper relative to the intermediate layer gripper can also be provided.

A relative mobility of the label roll gripper to the intermediate layer gripper is particularly advantageous.

FIG. 3 shows the gripper head 01 with at least one gripping apparatus 02 for label rolls 20 and with a receiving apparatus 03 for planar intermediate layers 30 in the first end position A of the receiving apparatus 03 for the planar intermediate layers 30, which is movable in a linear direction relative to the position of the gripping apparatus 02 location-variably and between two end positions A, B shown by way of example in FIGS. 3 and 4.

In a first end position A of the position-variable movability of the receiving apparatus 03 for the planar intermediate layers 30 relative to the position of the gripping apparatus 02 in a linear direction, which for short is referred to as the first linear position of the intermediate layer gripper relative to the label roll gripper, the gripper head 01, which can also be called a combination gripper or simply a gripper, serves to handle intermediate layers 30. For example, the gripper head 01 in the first linear position of the intermediate layer gripper relative to the label roll gripper serves to lift label rolls stacked between successive stack layers of towers standing vertically in alignment on top of one another and side by side on a pallet using the intermediate layer gripper.

FIG. 4 shows the gripper head 01 with at least one gripping apparatus 02 for label rolls 20 and with a receiving apparatus 03 for planar intermediate layers 30 in the second end position B of the receiving apparatus 03 for the planar intermediate layers 30, which is movable in a linear direction relative to the position of the gripping apparatus 02 location-variably and between two end positions A, B shown by way of example in FIGS. 3 and 4.

In a second end position B of the position-variable movability of the receiving apparatus 03 for the planar intermediate layers 30 relative to the position of the gripping apparatus 02 in the linear direction, which for short is referred to as the second linear position of the intermediate layer gripper relative to the label roll gripper, the combination gripper or gripper head 01 serves to handle label rolls 20. For example, the gripper head 01 in the second linear position of the intermediate layer gripper relative to the label roll gripper serves to lift label rolls 20 stacked vertically in alignment on top of each other in a plurality of towers standing next to each other on a pallet using the label roll gripper. In the second linear position, the label roll gripper can be used to simultaneously lift several label rolls 20 in one or successive stack layers, or to lift one label roll after another from the same or different towers of label rolls 20, provided that there is no intermediate layer 30 between successive stack layers. Once an intermediate layer 30 is reached, it must first be completely emptied by lifting the label rolls 20 located on it, in order to make the label rolls 20 below accessible by removing the intermediate layer in the first linear position of the intermediate layer gripper relative to the label roll gripper.

The gripper head 01 is therefore able to pick up and place either intermediate layers 30 or label rolls 20 in rapid succession by assuming two different end positions A, B of its receiving apparatus 03 for planar intermediate layers 30, which is location-variable in a linear direction relative to its gripping apparatus 02 for label rolls 20. This is done without a realignment of the gripper head 01, since to change between intermediate layers 30 and label rolls 20, only the switching between two linear positions of the intermediate layer gripper, which can also be described as relative positions, is done back and forth in relation to the label roll gripper which is advantageously fixed in the gripper head 01. In one of the two linear positions, the intermediate layer gripper is advantageously located in front of an engagement area of the label roll gripper, whereas in the remaining linear position it is withdrawn behind the engagement area of the label roll gripper. This allows the intermediate layer gripper to pick up an intermediate layer 30 in one of the two linear positions without the label roll gripper colliding with the intermediate layer 30. In the remaining of the two linear positions, the label roll gripper can be brought into engagement with one or more label rolls 20 without the intermediate layer gripper colliding with the label roll 20.

Due to the location-variable movability of the receiving apparatus 03 for the planar intermediate layers 30 in a linear direction relative to the position of the gripping apparatus 02 for label rolls 20, the receiving apparatus 03 passes either in front of or behind the engagement area of the gripping apparatus 02.

The gripper head 01 is distinguished by a linear traversability of the receiving apparatus 03 for planar intermediate layers 30 relative to the gripping apparatus 02 for grasping the label rolls 20. For example, the receiving apparatus 03 for planar intermediate layers 30 can be movable linearly relative to the gripping apparatus 02 for gripping the label rolls 20 along a, for example, central geometric axis 05 of the gripper head 01, which axis is normal to a gripper plane 04, for example is vertical.

Advantageously, the receiving apparatus 03 for planar intermediate layers 30 is movable location-variably relative to the gripping apparatus 02 for label rolls 20 in a linear direction along a, for example, central geometric axis 05 of the gripper head 01, which axis is normal to a gripper plane 04, for example is vertical, at least between two end positions A, B shown in FIGS. 3 and 4. This does not preclude the possibility of occupation of further relative positions between the two end positions A and B. Thus, the other relative positions can be adapted to different dimensions of different label rolls along the geometric axis 05. The end positions A, B can, for example, define a maximum dimension of a label roll that can be accommodated along the geometric axis 05. One or more additional relative positions may be assigned to thinner label rolls, such as those with smaller dimensions along the geometric axis 05 of the gripper head 01.

The gripper head 01 can comprise an automatically controllable actuating apparatus with at least one actuating means 34 for the location-variable movement of the receiving apparatus 03 for the planar intermediate layers 30, referred to as linear displacement for short, at least between two end positions A, B in a linear direction relative to the position of the gripping apparatus 02 for label rolls 20, which is advantageously arranged fixedly in the gripper head 01.

The receiving apparatus 03 for planar intermediate layers 30 can comprise one or more suction cups 31, also referred to as suction domes, suction tulips or suction heads, as means, also referred to as receiving means for short, for receiving intermediate layers 30, in order to grasp and receive intermediate layers 30 or to lift them from a pallet providing label rolls 20.

Such a receiving apparatus 03 is hereinafter also referred to as a suction unit.

Advantageously, the suction unit can be configured to be retrofitted to a label roll gripper.

As already mentioned, the receiving apparatus 03 for planar intermediate layers 30 can be linearly movable relative to the gripping apparatus 02 for label rolls 20 along, for example, a central geometric axis 05 of the gripper head 01, which axis is normal to a gripper plane 04, for example is vertical. Parallel to the so-called gripper plane 04, the label rolls 20 can be gripped from their inner and/or outer circumference. For example, the gripping apparatus 02 for label rolls 20 can advantageously have movable elements 21 parallel to the gripper plane 04, which, by moving apart from the geometric axis 05 of the gripper head 01, which is normal to the gripper plane 04 and is referred to as the gripper axis, are able to grip the label rolls 20 from their inner circumference. Alternatively or additionally, the gripping apparatus 02 for label rolls 20 can advantageously have movable elements parallel to the gripper plane 04 which, by moving together towards the gripper axis, are able to grip the label rolls 20 from their outer circumference.

The top and bottom surfaces of a label roll 20 picked up by the label roll gripper of the gripper head 01 extend parallel to the gripper plane 04. The winding axis of a label roll 20 picked up by the gripper head 01 rests normally on the gripper plane 04. It runs parallel to the geometric axis 05 of the gripper. It can coincide with the geometric axis 05 (FIG. 4).

The label roll gripper can have an engagement area that is necessary to pass a label roll 20 from above, inside and/or outside, in order to grip it on its inner and/or outer circumference, for example to clamp and/or grip from behind. This is only possible when corresponding movable elements 21 of the label roll gripper have been lowered from above over the top edge of a label roll 20. The engagement area can be defined by a space enclosed between two planes running parallel to the gripper plane 04 and spaced apart, for example, by the extent of the movable elements 21 along the geometric axis 05, and radially bounded by a predetermined radius around the geometric axis 05, proportional to, for example, the diameter of a label roll.

The intermediate layer gripper is advantageously located above the engagement area along the geometric axis 05 during handling of a label roll 20 in order to prevent a collision with the label roll.

Only when handling an intermediate layer 30 does the intermediate layer gripper, with its means for receiving intermediate layers 30, which are configured, for example, as suction cups 31 and are also referred to as receiving means, descend into the engagement area of the label roll gripper, which is advantageously free of a label roll 20 for handling an intermediate layer 30, so that a collision of the receiving means with the label roll 20 cannot occur there.

According to an advantageous embodiment of a gripper head 01, the gripping apparatus 02 for label rolls 20, referred to as a label roll gripper, can comprise a central, for example vertical, geometric axis 05 normal to a gripper plane 04, and at least two label roll gripper arms 22, which are uniformly distributed around the geometric axis 05, for example radially projecting from the geometric axis 05 in a star shape, for example movable parallel to the gripper plane 04 towards and away from each other, and configured to pack a label roll 20, the winding axis of which is aligned parallel to the geometric axis 05, on its inner and/or outer circumference, for example by clamping and/or gripping behind it.

In particular, with such a gripper head 01, the receiving apparatus 03, referred to as an intermediate layer gripper for short, for planar intermediate layers 30 can comprise at least one, preferably at least a number of intermediate layer receiving arms 32 corresponding to the number of label roll gripper arms 22, for example configured as intermediate layer suction arms, distributed evenly around the geometric axis 05 in a circumferential direction around the geometric axis 05 between the label roll gripper arms 22, movable jointly relative to these parallel to the geometric axis 05 (i.e. normal to the gripper plane 04) and radially spaced from it.

The gripping apparatus 03, referred to as a label roll gripper, for gripping the label rolls 30, preferably has at least one intermediate layer receiving arm 22, but preferably at least a number of intermediate layer receiving arms 22 corresponding to the number of label roll gripper arms 32, for example configured as intermediate layer suction arms, arranged in a circumferential direction around the geometric axis 05, evenly distributed around the geometric axis 05 between the label roll gripper arms 22, movable jointly relative thereto parallel to the geometric axis 05 and thus normal to the gripper plane 04, and spaced radially apart from the geometric axis 05.

Several suction cups 31 can be arranged on each intermediate layer receiving arm 32 of such a gripper head 01.

The intermediate layer receiving arms 32 can be connected to each other to form a common intermediate layer receiving element 33 which is arranged parallel to the geometric axis 05 and slidably on the label roll gripper 02.

The intermediate layer receiving element 33 or optionally the receiving apparatus 03 comprising it or comprised by it for planar intermediate layers 30 can advantageously be subsequently arranged on the label roll gripper 02 for required, if necessary modular, retrofitting and can also be removed again.

This allows the gripper head 01 according to the invention to be manufactured modularly as required.

Between the gripping apparatus 02 for label rolls 20 and the receiving apparatus 03 for planar intermediate layers 30 of the gripper head 01, for example between the label roll gripper and the intermediate layer gripper or intermediate layer receiving arms 32, at least one actuating means 34 can be arranged which controls, for example, a common movement between the two end positions in the linear direction, for example a movement of the intermediate layer receiving arms 32 relative to the label roll gripper arms 22 parallel to the geometric axis 05. Such an actuating means 34 can, for example, be implemented by one or more pneumatic cylinders.

The gripper head 01 can comprise recognition means differentiating between at least one label roll 20 and an intermediate layer 30. The recognition means advantageously allow not only recognition, but preferably also differentiation between at least one label roll 20 and an intermediate layer 30.

The gripper head 01 can alternatively or additionally comprise means for detecting a distance to at least one label roll 20 and/or to at least one intermediate layer 30.

These means for detecting distance can be non-contact, for example configured as an optical and/or acoustic sensor, or can be configured as a push button or contact switch, or can comprise such sensors or push buttons or combinations thereof, for example ultrasonic sensors.

Particularly advantageously, means configured as distance sensors for detecting a distance can be assigned to the receiving apparatus 03, preferably configured as a suction unit, for planar intermediate layers 30. This allows for the creation of a suction unit that can be retrofitted or replaced independently of any distance sensors that may be arranged on a gripper head.

As already mentioned, the gripper head 01 can be equipped with a gripping apparatus 02 for label rolls 20, which comprises means for gripping the label rolls 20 from their outer circumference.

Alternatively or additionally, the gripper head 01 can be equipped with a gripping apparatus 02 for label rolls 20, which comprises means for gripping the label rolls 20 from their inner circumference. Means for gripping the label rolls 20 from their inner circumference can be realized by movable elements 21 as described above.

A combination of gripping or grasping a label roll 20 from both its inner and outer circumference can be particularly advantageous for very large label rolls 20 or label rolls 20 with slippery label material. Label rolls typically have an inner core made of cardboard or plastic. Here, primary gripping is preferably carried out from the inner circumference of the label roll 20, for example by the means for gripping the label rolls 20 from their inner circumference, which are also referred to as inner grippers, since a large force can be applied here without damaging the sensitive label tape. The outside of the roll, however, is relatively sensitive, for example fragile, especially if the roll has not been wound tightly. Therefore, some rollers tend to telescoping when they are only mounted from their inner circumference.

This can be prevented by additional clamping of the label rolls 20 from the outer circumference, for example by the means for gripping the label rolls 20 from their outer circumference, which are also referred to as external grippers. Another advantage of using an external gripper is that it also allows handling of partially used rolls. The beginning of the tape is loose here. Without external grippers, the role in handling, especially repositioning or transport, would be lost.

The gripper head 01 can comprise a vacuum source 35 for the receiving apparatus 03, preferably configured as a suction unit, for planar intermediate layers 30. Such a vacuum source 35 can, for example, be implemented by one or more Venturi nozzles or comprise one or more Venturi nozzles.

According to a particularly advantageous embodiment, the gripper head 01 can comprise an associated magazine 06 with receiving mandrels 62, also referred to as holding mandrels, preferably provided with barbs 61 at their free ends for storing lifted intermediate layers 30.

The gripper head 01 can have a multi-part centering portion formed by, comprising, or comprised by the movable elements 21, which multi-part centering portion can be inserted into a central opening of a label roll 20 and can be radially extended from a central position, for example, which can be aligned with the geometric center of the central opening, while centering a label roll 20.

It is important to emphasize that the linear traverse movement of the intermediate layer gripper relative to the label roll gripper can be controlled, for example, by electric motors or pneumatics.

Provided that the means, also referred to as receiving means for short, for receiving intermediate layers 30 of the receiving apparatus 03 for planar intermediate layers 30, as seen within the gripper plane 04, project radially beyond a label roll 20 gripped by the label roll gripper in relation to a geometric axis 05, which, for example, is common to and corresponds with the winding axis of the label roll 20, it is also possible to simultaneously lift off, for example, the last label roll 20 lying on an intermediate layer 30 together with the intermediate layer 30 below it.

It is also important to emphasize that the invention can be realized by an apparatus for handling both label rolls and intermediate layers, which apparatus comprises a gripper head 01 described above in various embodiments and exemplary embodiments, which is advantageously arranged on a robot, for example an industrial robot or a robot arm, and can be moved by it within a spatial area. Such an apparatus can have a magazine 06 with receiving mandrels 62, which are preferably provided with barbs 61 at their free ends and are also referred to as holding mandrels, for storing intermediate layers 30 lifted by the gripper head 01.

A vacuum or negative pressure supply to means configured as suction cups 31, also referred to as receiving means for receiving intermediate layers 30, can be provided by a radial blower, a vacuum pump or a Venturi nozzle or a so-called ejector.

As can be seen in FIGS. 1, 2, 3, and 4, the receiving apparatus 03 can comprise a plurality of suction cups 31, also referred to as vacuum suckers, as receiving means with which the intermediate layers 30 are suctioned up and lifted from the pallet. To avoid a collision with the label rolls 20, the vacuum suckers are mounted in a linearly movable manner. When the gripper head 01 is to lift label rolls 20, the vacuum suckers are retracted, i.e., in the upper position shown in FIG. 4, designated as end position B. Label rolls 20 can thus be picked up without collision with the movable elements 21 on the underside, which are realized, for example, by three clamping jaws. In order to lift off intermediate layers 30, the vacuum suckers are brought into the lower position shown in FIG. 3, designated as end position A. In this position, they extend beyond the clamping jaws of the label roll gripper and are thus able to pick up the intermediate layers 30 from the pallet. The linear traversing movement of the vacuum suckers is preferably pneumatically controlled. An electric actuation is also conceivable.

Advantageously, a camera is located on the gripper head 01, for example on the label roll gripper, to detect the roll cores for picking up the label rolls 20 by the label roll gripper, which can also be described as a centric gripper. This camera can also be used to detect the presence of a removable intermediate layer 30.

To determine the distance of the vacuum suckers from the intermediate layer 30 to be picked up, the distance sensors provided on the label roll gripper configured as the main gripper of the gripper head 01 can be used. This allows the robot to approach intermediate layer 30 in a targeted manner without the risk of damage to the vacuum suckers.

Preferably, the Venturi nozzles, which supply the vacuum suckers with vacuum, are supplied with compressed air via a permanent compressed air supply. This ensures that even in the event of an emergency stop of the machine or an opening of the protective area, the intermediate layers 30 are securely held on the vacuum suckers. This prevents the intermediate layer 30 from falling uncontrollably. Once operations have resumed, the intermediate layer 30 can be safely deposited and the process can be continued seamlessly.

The vacuum for the vacuum suckers is preferably generated near the suckers using Venturi nozzles.

In the simplest case, the intermediate layers 30 lifted from the pallets are placed in another location and stacked there.

The stacked intermediate layers 30 can, when the opportunity arises, be transferred again with the gripper head 01 to a ready, empty pallet, which is then moved out of the robot cell again, for example by an operator using a pallet truck or automatically using a so-called AGV or mobile robot.

In order to ensure a reliable placement of the lifted intermediate layers 30, it may be provided that the vacuum grippers are briefly pressurized with compressed air when placing the intermediate layers 30. This so-called counter-blowing action allows the intermediate layers 30 to be pressed off the vacuum suckers.

In addition to laying them flat, it is also conceivable that the robot feeds the lifted intermediate layers 30 to a press or a shredder.

For space-saving temporary storage of the lifted intermediate layers 30, another approach is also possible: The intermediate layers 30 can be speared onto receiving mandrels 62, which are referred to as mandrels for short, as already described with respect to the magazine 06, so that they can be stored in a vertical orientation. This has the advantage that many intermediate layers 30 can be stored on a very small footprint. Likewise, very little hall floor space is used or consumed, as the impaled intermediate layers 30 can also be located at a certain height above the floor.

The gripper head 01 presses the intermediate layers 30 in a vertical orientation onto the two mandrels, wherein the number of mandrels provided can vary. Barbs 61 on the mandrels prevent the intermediate layers from falling off.

It is evident that the invention can be realized by a gripper head 01 as described above, or by an apparatus comprising such a gripper head for handling label rolls 20 and intermediate layers 30, for example comprising a label roll gripper with a central geometric axis 05, which is normal to a gripper plane 04, for example is vertical, and at least two label roll gripper arms 22, which are distributed uniformly around the geometric axis 05, for example radially projecting from the geometric axis 05 in a star shape, for example parallel to the gripper plane 04, and movable towards and away from each other, and configured to pack a label roll 20, the winding axis of which is aligned parallel to the geometric axis 05, at its inner and/or outer circumference, for example by clamping and/or gripping behind it, wherein at least a number of intermediate layer receiving arms 32, corresponding to the number of label roll gripper arms 22 and configured, for example, as intermediate layer gripper arms, are arranged on the label roll gripper 02 distributed uniformly around the geometric axis 05 as seen in a circumferential direction around the geometric axis 05 between the label roll gripper arms 22, movably jointly relative thereto parallel to the geometric axis 05 (i.e., normal to the gripper plane 04) and radially spaced from it.

The receiving apparatus 03 for planar intermediate layers 30 can, as described, comprise one or more suction cups 31, also referred to as suction domes, suction tulips or suction heads, as means, also referred to as receiving means for short, for receiving intermediate layers 30, in order to grasp and receive intermediate layers 30 or to lift them from a pallet providing label rolls 20. Alternatively or additionally, the receiving apparatus 03 for planar intermediate layers 30 can, for example, comprise so-called needle grippers or electro-adhesion grippers.

Alternatively or in addition to the above embodiments, instead of the entire receiving apparatus 03 for the planar intermediate layers 30, only the means for receiving intermediate layers 30, also referred to as receiving means for short, can be movable in a linear direction location-variably relative to the position of the gripping apparatus 02 and between two end positions A, B shown by way of example in FIGS. 3 and 4. According to this, not the entire receiving apparatus 03 needs to be location-variable, but only parts of it, such as the suction cups 31 and all other components attached to the actuating means 34 that generates the traversing movement.

Additional advantages over the prior art, beyond a complete solution to the problem posed and/or beyond the advantages mentioned above for the individual features, are as follows.

A gripper head 01 described above allows the realization of an apparatus and a method for operator-free label roll changing.

In principle, the apparatus and method for operator-free label roll changing described above are also suitable for changing other palletized material in roll format with intermediate layers without an operator. One example is rolls of film, which are also provided on pallets with intermediate layers. This could include, for example, rolls of film, such as those used in so-called stretch wrappers.

The invention has been described with reference to preferred embodiments. However, it is conceivable for a person skilled in the art that modifications or changes can be made to the invention without departing from the scope of protection of the following claims.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed and claimable independently of all features of independent claim 1 and, for example, independently of the features relating to the presence and/or the configuration of the gripping apparatus and/or of the receiving apparatus of independent claim 1. All ranges specified herein are to be understood as disclosed and claimable in such a way that all values falling within the relevant range are individually disclosed, e.g., also as the relevant preferred narrower outer limits of the relevant range.

### LIST OF REFERENCE SIGNS

01 gripper head

02 gripping apparatus

03 receiving apparatus

04 gripper plane

05 geometric axis

06 magazine

20 label roll

21 element

22 label roll gripper arm

30 intermediate layer

31 suction cup

32 intermediate layer receiving arm

33 intermediate layer receiving element

34 actuating means

61 barb

62 receiving mandrels

A end position

B END POSITION

What is claimed is:

1. A gripper head comprising:
at least one gripping apparatus for label rolls;
a receiving apparatus for planar intermediate layers; and
wherein the gripping apparatus for gripping the label rolls is fixedly arranged in the gripper head, while the receiving apparatus for the planar intermediate layers is movable in a linear direction relative to the position of the gripping apparatus location-variably and between two end positions.

2. The gripper head according to claim 1, wherein the receiving apparatus for planar intermediate layers comprises one or more suction cups.

3. The gripper head according to claim 1, wherein the receiving apparatus for planar intermediate layers is movable in a linear direction along a geometric axis of the gripper head relative to the gripping apparatus for label rolls location-variably between two end positions.

4. The gripper head according to claim 1, wherein the gripping apparatus for label rolls comprises a central geometric axis, and at least two label roll gripper arms arranged uniformly distributed around the geometric axis.

5. The gripper head according to claim 4, wherein the receiving apparatus for planar intermediate layers comprises at least one intermediate layer receiving arm movable in a circumferential direction about the geometric axis between the label roll gripper arms relative thereto parallel to the geometric axis and radially spaced from it.

6. The gripper head according to claim 5, wherein several suction cups are arranged on each intermediate layer receiving arm.

7. The gripper head according to claim 5, wherein the intermediate layer receiving arms are connected to each other to form a common intermediate layer receiving element which is arranged parallel to the geometric axis and is slidable on the gripping apparatus.

8. The gripper head according to claim 7, wherein the intermediate layer receiving element can be subsequently arranged on the gripping apparatus and can also be removed again.

9. The gripper head according to claim 1, wherein at least one actuating means controlling a movement between the two end positions in the linear direction is arranged between the gripping apparatus and the receiving apparatus.

10. The gripper head according to claim 1, wherein the gripper head comprises distinguishing recognition means between at least one label roll and an intermediate layer.

11. The gripper head according to claim 1, wherein the gripper head comprises means for detecting a distance at least to at least one label roll and/or an intermediate layer.

12. The gripper head according to claim 1, wherein the gripping apparatus comprises means for gripping the label rolls from their outer circumference.

13. The gripper head according to claim 1, wherein the gripping apparatus comprises means for gripping the label rolls from their inner circumference.

14. The gripper head according to claim 1, wherein it comprises a vacuum source for the receiving apparatus.

15. The gripper head according to claim 1, comprising a magazine associated therewith with receiving mandrels for depositing lifted intermediate layers.
